(19) United States
(12) Patent Application Publication
(10) Pub. No.: US 2024/0251196 A1
(43) Pub. Date: Jul. 25, 2024

(54) METHOD FOR OPERATING A HEARING DEVICE

(71) Applicant: Sivantos Pte. Ltd., Singapore (SG)

(72) Inventors: Cecil Wilson, Erlangen (DE); Alastair James Manders, Erlangen (DE); Sascha Bilert, Erlangen (DE)

(21) Appl. No.: 18/409,261

(22) Filed: Jan. 10, 2024

(30) Foreign Application Priority Data
Jan. 19, 2023 (DE) 10 2023 200 412.7

(51) Int. Cl. H04R 1/10; G01P 15/18; H04R 25/00

(52) U.S. Cl. CPC H04R 1/1083; G01P 15/18; H04R 25/505; H04R 2225/41; H04R 2410/07; H04R 2460/01

(57) ABSTRACT

A method for operating a hearing device, in particular a hearing aid, which has a wind noise canceller and a motion sensor, includes adjusting the wind noise canceller as a function of measurement data recorded by the motion sensor. A hearing device which is operated according to the method is also provided.

The invention relates to a method for operating a hearing device and to a hearing device. The hearing device respectively has a wind noise canceller and a motion sensor. The hearing device is preferentially a hearing aid.

Persons who suffer from a reduction of hearing conventionally use a hearing aid. Ambient sound is in this case converted into an electrical (audio/sound) signal, usually by means of a microphone, that is to say an electromechanical sound transducer, so that the ambient sound is recorded. The electrical (sound) signals are processed by means of an amplifier circuit and introduced into the auditory canal of the person by means of a further electromechanical transducer in the form of a receiver. Processing of the sound signals usually also takes place, for which a signal processor of the amplifier circuit is conventionally used. The amplification is in this case adapted to any hearing loss of the hearing device wearer.

If the microphone is exposed to wind, resulting wind noises are recorded and are consequently present in the sound signal. As a result of this, the wind noises are likewise introduced, in part having been processed, into the auditory canal of the person, for which reason other constituents of the electrical signal, which for example correspond to a conversation with an interlocutor, cannot be perceived by the person or can be perceived only with effort, which makes the convenience relatively poor.

As a remedy for this, it is for example possible to provide the microphone with mechanical shielding. This, however, leads to an increased overall size of the hearing device, so that it is relatively conspicuous. As an alternative to this, processing of the electrical signal is performed in order to filter out the wind noises at least partially. A wind noise canceller is conventionally used for this. Non-stationary components that have a relatively low frequency are usually removed by means of the latter. If a plurality of microphone units are present, with the aid of which a corresponding electrical signal is respectively compiled, the mutually uncontrolled constituents of the two electrical signals are filtered out.

If the adjusted filter effect is relatively low, the wind noises nevertheless continue to be perceptible by the person, albeit to a reduced extent, for which reason the convenience is reduced. If relatively comprehensive filtering is carried out, however, it is possible that desired components in the electrical signal will also be removed so that, for example, the person can no longer entirely follow a conversation. This also reduces the convenience. It is necessary to select a compromise in the adjustment of a wind noise canceller as a result of this, for which reason wind noises are still perceptible by the wearer of the hearing device in relatively windy situations. It is in this case still possible to filter out desired constituents in relatively windless situations.

The object of the invention is to provide a particularly suitable method for operating a hearing device and a particularly suitable hearing device, the convenience for a wearer being increased in particular.

This object is achieved according to the invention in respect of the method by the features of claim 1, and in respect of the hearing device by the features of claim 7. The respective dependent claims relate to advantageous developments and configurations.

The method is used to operate a hearing device. For example, the hearing device is an earphone or comprises an earphone. As an alternative, the hearing device is a headset, true wireless headphone, hearable, or personal sound amplifier. Particularly preferentially, however, the hearing device is a hearing aid. A hearing aid is used to assist a person who is suffering from a reduction of their hearing. In other words, a hearing aid is a medical device which, for example, compensates for a partial hearing loss. The hearing aid is for example a “receiver-in-the-canal” hearing aid (RIC; ex-receiver hearing aid), an “in-the-ear” hearing aid, an “in-the-canal” hearing aid (ITC) or a “completely-in-the-canal” hearing aid (CIC), a spectacle hearing aid, a pocket hearing aid, a bone conduction hearing aid or an implant. In a further alternative, the hearing aid is a “behind-the-ear” hearing aid which is worn behind a pinna.

The hearing device is intended and adapted to be worn on the human body. In other words, the hearing device preferentially comprises a holding instrument by means of which fastening on the human body is possible. If the hearing device is a hearing aid, the hearing device is intended and adapted, for example, to be arranged behind the ear or inside an auditory canal. In particular, the hearing aid is wireless and intended and adapted to be inserted at least partially into an auditory canal. Particularly preferentially, the hearing device comprises an energy storage unit by means of which an energy supply is provided.

The hearing device suitably comprises a microphone which is used to record sound. In particular, an ambient sound or at least a part thereof is recorded during operation by means of the microphone. The microphone is, in particular, an electromechanical sound transducer. The microphone has for example only a single microphone unit, or a plurality of microphone units which interact with one another. Each of the microphone units expediently has a membrane that is set in oscillation with the aid of sound waves, the oscillations being converted into an electrical signal by means of a corresponding pickup device, such as a magnet which is moved in a coil. By means of the respective microphone unit, it is therefore possible to record an audio (electrical signal/sound signal) that is based on the sound to which the microphone unit is exposed. The microphone units are, in particular, configured to be unidirectional. The microphone is expediently arranged at least partially inside a housing of the hearing device, and therefore at least partially protected.

Expediently, the hearing device has a receiver for emitting an output signal. The output signal is in this case, in particular, an electrical signal. The receiver is an electromechanical sound transducer, preferably a loudspeaker. Depending on the configuration of the hearing device, in the intended state the receiver is arranged at least partially inside an auditory canal of a wearer (user) of the hearing device, that is to say a person, or is at least acoustically connected thereto. The hearing device is, in particular, primarily used to emit the output signal by means of the receiver, corresponding sound being created. In other words, the main function of the hearing device is to emit the output signal. The output signal is in this case compiled at least partially as a function of the sound recorded by means of the microphone.

The hearing device expediently comprises a signal processing unit (signal processing circuit), which is for example arranged in the housing. Preferably in this case, the signal processing unit is arranged in terms of signaling between the microphone and the possible receiver, and the possible audio signal compiled by means of the microphone is delivered during operation to the signal processing unit and, in particular, processed there. It is subsequently delivered to the receiver, so that the processed audio signal is emitted.

The signal processing unit is suitably adjustable. In other words, it is possible to modify individual parameters/values/single values of the signal processing unit.

The signal processing circuit comprises, for example, a digital signal processor (DSP) and/or electrical/electronic constituent parts. In particular, the signal processing unit comprises an amplifier. As an alternative thereto or in combination therewith, the signal processing unit comprises a noise cancellation unit (“adaptive noise canceller”), “adaptive feedback cancellation” and/or an adjustment unit for the microphone of the hearing device, a directional characteristic (directionality) being for example modified or at least adapted as a function of the adjustment of the microphone. In particular, a directional characteristic of the microphone is in this case switched between omnidirectional and directional pickup. For example, a directional lobe of the microphone is in this case adjusted, that is to say in particular a beam width and/or alignment. In other words, an adjustment of the beamformer is carried out by means of the signal processing unit.

The hearing device further has a wind noise canceller, which is expediently configured to be adaptive. The wind noise canceller is in this case a unit for processing the electrical signal/audio signal and/or a constituent of the possible signal processing unit. By means of the wind noise canceller (WNC, “wind noise canceller/reduction”), it is in this case possible at least partially to remove wind noises present in the audio signal. In particular, the wind noise canceller is in this case arranged in terms of signaling between the possible microphone and the receiver.

Non-stationary components, which in particular have a low frequency, are preferably identified in the supplied signal, preferably in the audio signal, by means of the wind noise canceller during operation. These are expediently at least partially removed, or their relative proportion is reduced. As an alternative thereto or in combination therewith, for example, if a plurality of such (audio) signals are present, each of which has been compiled by means of a respective microphone unit, components not correlated with one another are identified therein and these are removed/reduced. The reduction of the respective components is carried out, in particular, as a function of an adjustment of the wind noise canceller. In other words, it is possible to specify or at least influence the component to be removed by means of an adjustment of the wind noise canceller.

Further, the hearing device has a motion sensor, which is for example an acceleration sensor. For example, the motion sensor is a constituent part of a gyroscope or is formed by means of a gyroscope. By means of the motion sensor, in particular only a relative movement, in particular an acceleration, is recorded during operation. During operation in this case, the motion sensor compiles in particular measurement data in which the recorded movement is expediently stored. When the hearing device is moved, the movement can therefore be recorded by means of the motion sensor. If the hearing device is a hearing aid, which is in particular worn on the ear, with the aid of the measurement data compiled by means of the motion sensor it is therefore possible to determine a movement and/or alignment of the head of the hearing aid wearer (user, wearer) and preferably a profile of the movement of the head as a function of time. Preferably, the possible signal processing unit is signal-coupled to the motion sensor so that the measurement data compiled by means of the motion sensor can be evaluated by means of the signal processing unit.

According to the method, measurement data are recorded by means of the motion sensor. The measurement data in this case correspond, for example, to the data compiled directly by means of the sensor, and are in particular unprocessed. As an alternative thereto, the measurement data are data processed by means of the motion sensor or another constituent part of the hearing device. The wind noise canceller is adjusted as a function of the recorded measurement data. As a result of this, the wind noise canceller is therefore adjusted as a function of a movement of the hearing device, so that the wind noise canceller is adjusted in a different way for different movements of the hearing device. Since the hearing device is worn by a person, and since a different movement of the head takes place during different activities of the wearer, the wind noise canceller is adjusted as a function of an activity of the wearer of the hearing aid.

If a relatively comprehensive movement of the wearer therefore takes place, that is say they are for example engaging in a sport, the wind noise canceller is expediently adjusted in such a way that the component to be removed/cancelled is increased. Since such activities are usually carried out in the open air and a relatively pronounced movement of the head of the wearer of the hearing device takes place during such activities, the component of the wind noises recorded by means of the possible microphone is relatively high. Moreover, such head movements lead to a high relative wind in respect of the hearing device and therefore also to increased wind noises. Since the wind noise canceller is correspondingly adjusted, the wind noises are filtered out relatively strongly so that they are perceptible only to a small extent by the wearer. Conversely, in the case of a hearing device held relatively still, there is usually a low-wind situation, for example when visiting a theatre. In the case of small movements, the component filtered out/cancelled by means of the wind noise canceller is preferably reduced. In particular, the enjoyment of the theatre is therefore increased for the hearing aid wearer. In particular, intelligibility during a conversation is also increased, since only a relatively small movement of the head likewise takes place in this case. Because of the method, the hearing aid wearer is therefore spared from being burdened with relatively high wind noises, although relatively low filtering out of desired components nevertheless takes place when the hearing device is held still. The convenience is therefore increased.

For example, further adjustments of the hearing device are also carried out as a function of the measurement data recorded by means of the motion sensor. In particular, the possible (adaptive) noise cancellation unit and/or the possible (adaptive) feedback cancellation unit is adjusted according to the measurement data or at least as a function thereof. At least, it is preferentially adjusted as a function of the adjustment of the wind noise canceller. For example, the adaptive noise cancellation unit is adjusted in such a way that noise is filtered out more in the case of an increased filter effect of the wind noise canceller. As an alternative thereto or in combination therewith, for example, the adjustment of the microphone is modified. In particular, a directional effect of the microphone is modified in the case of a relatively comprehensive movement of the hearing device. Preferably, in this case the directionality is reduced and, for example, the microphone is set to be omnidirectional.

For example, a movement is likewise recorded by means of a further motion sensor, which in particular is a constituent part of an external device. The external device is expediently signal-coupled to the hearing device, preferably by means of radio, and is for example a portable device, preferably a smartphone or another wearable. In particular, this ensures that a particular range, for example 5 m, of the external device from the hearing device is not exceeded. Preferably, further measurement data of the further acceleration sensor are provided by means of the external device and the wind noise canceller is also adjusted as a function of the further measurement data. Thus, for example, it is possible to identify relatively rapid movement of the user, for example in the scope of bicycling or the like, or another relatively rapid forward movement of the user. In these situations, a relative wind occurs more greatly and leads to exacerbated wind noises. Preferably, in this case the wind noise canceller is adjusted in such a way that background noises, that is to say wind noises, are filtered out to an increased extent.

In particular, the invention also relates to such a hearing device system that comprises an external device and the hearing device, which are signal-coupled or can be signal-coupled to one another, preferably by means of radio. The invention further relates to a method for operating such a hearing device system, which comprises the method for operating the hearing device, the external device additionally providing further measurement data that have been compiled by means of the further motion sensor of the external device. The adjustment of the wind noise canceller is also carried out as a function of the further measurement data in this case.

For example, the component to be removed/cancelled by means of the wind noise canceller of the possible audio signal is specified by means of the measurement data. Particularly preferentially, however, a maximum cancellation performance of the wind noise canceller is adjusted as a function of the measurement data. In other words, the component to be removed or cancelled is not specified directly by means of the measurement data, but instead the maximum removal/cancellable component is specified. The actual/currently removed/cancelled component is preferably specified with the aid of further properties and/or parameters, in particular with the aid of an analysis of the possible audio signal. Preferably, the actual/currently removed/cancelled component is specified with the aid of non-stationary constituents and/or the constituents of the audio signal with relatively low frequencies. It is therefore possible that only a small component is filtered out from the audio signal, that is to say removed, even in the case of a relatively high maximum cancellation performance. A part of the adjustment of the wind noise canceller therefore continues to be carried out with the aid of the audio signal. It is therefore possible to deal relatively accurately with the current situation, although the maximum cancellation performance is increased for particular activities in which, in particular, the likelihood of wind noises is increased.

As an alternative thereto or in combination therewith, a minimum cancellation performance is adjusted as a function of the measurement data. In other words, the component which at the very least is removed from the audio signal is specified in particular. Preferably, the minimum cancellation performance is increased for measurement data that correspond to a relatively comprehensive movement of the hearing device, since increased wind noises are then to be expected. This ensures that the component filtered out is increased in the case of relatively comprehensive movements of the hearing device, which directly lead to wind noises because of the relative movement.

As an alternative thereto or in combination therewith, an adaptation rate of the wind noise canceller is adjusted, that is to say how fast a current cancellation performance is modified in the event of changing parameters or properties of the audio signal. For instance, particularly for measurement data which correspond to a comprehensive movement, the adaptation rate is increased so that it is possible to react relatively rapidly to a change of the wind noises. For relatively small movements of the hearing device, on the other hand, the adaptation rate of the wind noise canceller is selected to be relatively low so that transiently occurring noises are not cancelled. In the case of small movements, these are usually attributable not to wind but to sound which the wearer would like to hear.

For example, the wind noise canceller is adjusted continuously with the aid of the measurement data. Particularly preferentially, however, a classification of an activity of the user, that is to say of the wearer, of the hearing device is carried out with the aid of the measurement data. The wind noise canceller is in this case adjusted as a function of the respective class. In other words, there are a plurality of discrete stages for the adjustment of the wind noise canceller, each stage being assigned a different class of the various classes. In particular, one of the classes is the user sitting, one of the classes is the user walking, one of the classes is the user running, and/or one of the classes is the user bicycling. When sitting, the component to be removed by means of the wind noise canceller is relatively small, while it is increased when walking. When running, it is increased further, and even more when bicycling. For example, there are even more such classes, or the four classes are definitive. As an alternative or in combination, it is preferable that further adjustments of the hearing device are also carried out as a function of the classification, and in particular the noise cancellation unit is adjusted as a function of the classification of the activity. In one development, a directional effect of the microphone is also adjusted as a function of the respective class.

Particularly preferentially, a variance of the measurement data is ascertained for successive time intervals. The wind noise canceller is adjusted as a function of the ascertained variance, and therefore with the aid of the recorded measurement data. In particular, the possible classification of the activity is in this case carried out with the aid of the variance. In the case of a relatively high variance, a relatively comprehensive alternating movement of the hearing device takes place, so that there is also a relatively high relative wind component to which the possible microphone is exposed, so that relatively high wind noises are to be expected. With the aid of the variance, a relatively accurate adjustment of the wind noise canceller, adapted to the respective current situation, is therefore possible. Only relatively few resources are in this case necessary for determining the variance, thereby reducing complexity for carrying out the method and consequently hardware requirements. For example, the measurement data are already present one-dimensionally. Expediently, however, they describe a three-dimensional vector. In particular, the variance of the length of the vector is ascertained in this case. In particular, the length of the time intervals is between 1 second and 30 seconds or between 5 seconds and 20 seconds, and expediently equal to 15 seconds. Reliable determination of the variance is made possible in this way, although an adaptation of the adjustment of the wind noise canceller nevertheless takes place relatively rapidly in the event of a change of activity of the wearer of the hearing device.

The hearing device preferably has a microphone and/or a receiver, between which in particular a signal processing unit is signal-connected. In particular, the latter forms a signal path, and the microphone is preferably used to record sound and the receiver is suitably used to emit sound. For example, the hearing device is an earphone or comprises an earphone. The hearing device is in this case configured, for example, as a so-called headset. Particularly preferentially, however, the hearing device is a hearing aid. A hearing aid is used to assist a person who is suffering from a reduction of their hearing. In other words, a hearing aid is a medical device which, for example, compensates for a partial hearing loss. The hearing aid is for example a “receiver-in-the-canal” hearing aid (RIC; ex-receiver hearing aid), an “in-the-ear” hearing aid, an “in-the-canal” hearing aid (ITC), a “completely-in-the-canal” hearing aid (CIC), or an “invisible-in-the-canal” hearing aid (IIC), a spectacle hearing aid or a pocket hearing aid. Particularly preferentially, the hearing aid is a “behind-the-ear” hearing aid which is worn behind a pinna.

The hearing device has a wind noise canceller, which is used to remove/reduce/cancel wind noises. The wind noise canceller is suitable, in particular intended and adapted, for this purpose. Expediently, the wind noise canceller is used to cancel only wind noises, but not other (background) noises. The hearing device also has a motion sensor. Preferably, the motion sensor is arranged in a housing of the hearing device, inside of which the wind noise canceller is preferably also arranged. In particular, the motion sensor is a three-dimensional motion sensor, so that three-dimensional movements can thereby be recorded. In particular, the motion sensor is a hardware sensor.

The hearing device is operated according to a method in which the wind noise canceller is adjusted as a function of measurement data recorded by means of the motion sensor. Expediently, the signal processing unit is suitable, in particular intended and adapted, to carry out the method at least partially. For example, an analysis of the measurement data is carried out by means of the signal processing unit.

Expediently, the hearing device comprises a signal processor which suitably forms the signal processing unit or is at least a constituent part thereof. The signal processor is, for example, a digital signal processor (DSP) or embodied by means of analog components. By means of the signal processor, an adaptation of an (audio) signal compiled by means of the microphone is especially also carried out, preferably as a function of any hearing loss of a wearer of the hearing device. Expediently, an A/D converter is arranged between the microphone and the signal processing unit, for example the signal processor, if the signal processor is configured as a digital signal processor. The signal processor is, in particular, adjusted as a function of a parameter set. By means of the parameter set, a gain in different frequency ranges is specified, so that the signal compiled by means of the microphone is processed according to particular specifications, in particular as a function of any hearing loss of the wearer of the hearing device.

Particularly preferentially, the hearing device additionally comprises an amplifier or the amplifier is formed at least partially by means of the signal processor. For example, the amplifier is signal-connected upstream or downstream of the signal processor.

The developments and advantages described in connection with the two methods may be applied correspondingly to the hearing device/the hearing device system, as well as to one another, and vice versa.

An exemplary embodiment of the invention will be explained in more detail below with the aid of a drawing, in which:

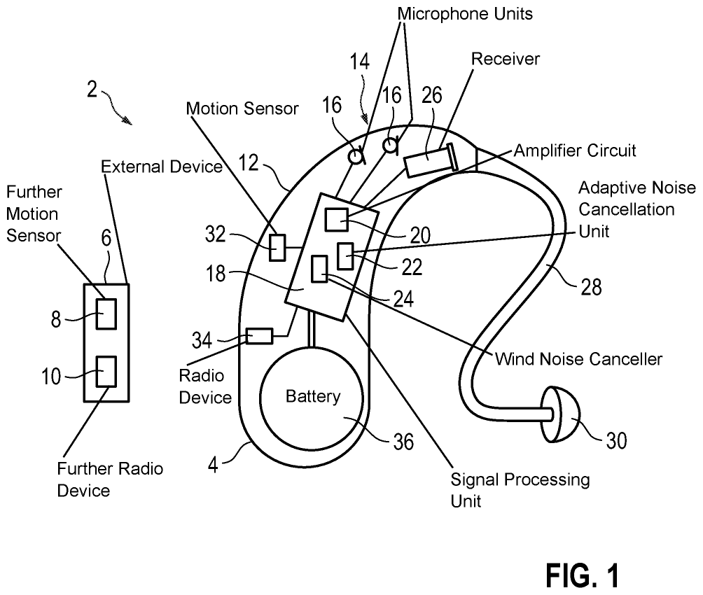

FIG. 1 schematically shows a hearing device system having a hearing device and an external device,

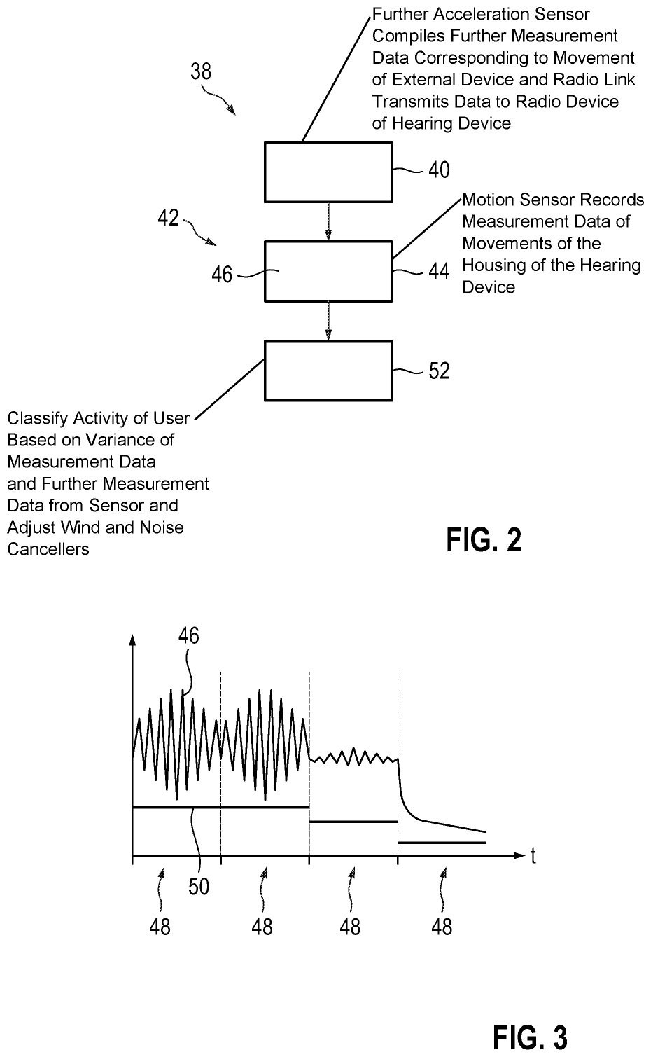

FIG. 2 shows a method for operating the hearing device system, which comprises a method for operating the hearing device, and

FIG. 3 shows the time profile of measurement data of a motion sensor of the hearing device.

Parts which correspond to one another are provided with the same reference signs in all the figures.

FIG. 1 shows a simplified schematic representation of a hearing device system 2, which has a hearing device 4 and an external device 6. The external device 6 is configured as a smartphone and has a further motion sensor 8 as well as a further radio device 10, which complies with a Bluetooth standard. Three-dimensional movement of the external device 6 can be recorded by means of the further motion sensor 8.

The hearing device 4 is configured as a hearing aid, which is intended and adapted to be worn behind an ear of a wearer (operator, hearing device wearer, user). In other words, it is a “behind-the-ear” hearing aid. The hearing device 4 comprises a housing 12, which is made from a plastic. Arranged inside the housing 12, there is a microphone 14 having two microphone units 16, each in the form of electromechanical sound transducers which are configured to be omnidirectional. By varying a time offset between the audio signals (acoustic signals) recorded by means of the omnidirectional microphone units 16, a directional characteristic of the microphone 14 can be modified so that a directional microphone is produced. The two microphone units 16 are signal-coupled to a signal processing unit 18, which comprises an amplifier circuit 20 having a signal processor. The signal processing unit 18 is further formed by means of circuit elements, for example electrical and/or electronic constituent parts. The signal processor is a digital signal processor (DSP) and is signal-connected to the microphone units 16 by means of an A/D converter (not represented in detail).

The signal processing unit 18 further has an adaptive noise cancellation unit (ANC) 22, which is used to ascertain and remove background noises in the audio signals compiled by means of the two microphone units 16 during operation. The signal processing unit 18 also comprises a wind noise canceller 24, which is used to ascertain and remove wind noises in the audio signals compiled by means of the two microphone units 16 during operation. The wind noises are in this case likewise perceived as interference by a wearer of the hearing device 4, but have different properties in comparison with the background noises. For instance, the background noises are in particular artificial in origin and are caused for example by a refrigerator or the like. The wind noises, on the other hand, are caused by a wind to which the microphone unit 16 is exposed, so that they are non-stationary and have relatively low frequencies. In one variant, the noise cancellation unit 22 and/or the wind noise canceller 24 are formed at least partially or entirely by means of software routines and/or the signal processor.

During operation, the microphone unit 16 respectively provides audio signals which are processed further by means of the signal processing unit 18. From these, background noises are removed by means of the noise cancellation unit 22 and wind noises are removed by means of the wind noise canceller 24, and subsequent frequency-selective amplification is carried out by means of the amplifier circuit 20 as a function of a hearing loss of the wearer of the hearing device 4. Further, the two audio signals are combined to form a common signal.

The signal compiled in this way is provided and delivered to a receiver 26 that is signal-coupled to the signal processing unit 18. By means of the receiver 26, which is an electromechanical sound transducer, during operation the (electrical) signal provided by means of the signal processing unit 18 is converted into an output sound, that is to say into sound waves. These are introduced into a sound tube 28, one end of which is fastened on the housing 12. The other end of the sound tube 28 is enclosed by a dome, which in the intended state is arranged in an auditory canal (not represented in detail here) of the wearer of the hearing device 4.

A motion sensor 32, which is an acceleration sensor or at least comprises the latter, is further arranged inside the housing 12. It is therefore possible to measure an acceleration of the housing 12 by means of the motion sensor 32 and also to ascertain a current position of the housing 12 therefrom, in particular by means of integration. It is in this case also possible to determine an inclination of the housing 12 and therefore also of a head of the wearer 2. A radio device 34, which complies with a Bluetooth standard and by means of which a radio link to the external device 6 is established, is further arranged inside the housing 12.

The signal processing unit 18 is powered by means of a battery 36 arranged in the housing 12. From the signal processing unit 18, a part of the electrical energy is delivered to the motion sensor 32 and to the radio device 34. The microphone 14 and the receiver 26 are also operated by means of this electrical energy.

The hearing device system 2 is operated according to a method 38 represented in FIG. 2 for operating a hearing device system. In a further first working step 40, further measurement data that correspond to the movement of the external device 6 are compiled by means of the further acceleration sensor 8. The further measurement data are radio-transmitted by the further radio link 10 to the radio device 34 of the hearing device 4 and are therefore received by the hearing device 4. Knowledge relating to the movement of the external device 6 is therefore provided in the hearing device 4. A method 42 for operating a hearing device 4 is subsequently started. In other words, the method 38 for operating a hearing device system 2 comprises the method 42 for operating a hearing device 4.

In a first working step 44 of the method 42 for operating a hearing device 4, which corresponds to the second method step of the method 38 for operating a hearing device system 2, measurement data 46 are recorded by means of the motion sensor 32. The movements of the housing 12 of the hearing device 4 are in this case recorded three-dimensionally by means of the motion sensor 32 and stored as a vector that has a particular length, which is subsequently processed further and the time profile of which is represented in FIG. 3.

For successive time intervals 48, each of which lasts 15 seconds, a variance 50 of the measurement data 46, that is to say the variance of the length of the three-dimensional vector, is determined. In the example represented, the variance 50 is relatively high and of the same order of magnitude in the first two time intervals 48. The variance 50 is lower in the next time interval 48, and is reduced further in the last time interval 48 represented. In summary, the variance 50 of the measurement data 46 is therefore ascertained for successive time intervals 48.

In a subsequent second working step 52, an activity of a user of the hearing device 4, that is to say of the wearer of the hearing device, is classified with the aid of the variance 50 and therefore with the aid of the measurement data 46. A total of four different classes of activity are available in this case, namely bicycling, running, walking and sitting. The variance 50 is relatively low when sitting, as in the last time interval 48 represented. When walking, the variance 50 is increased somewhat, as in the penultimate time interval 48 represented in FIG. 3. When running and when bicycling, conversely, the variance 50 is relatively high, as in the first two time intervals 48. The further measurement data compiled by means of the further motion sensor 8 are further taken into account during the classification. If the external device 6 is moved with a relatively high speed but uniformly, bicycling is used as the class. If a nonuniform movement takes place, on the other hand, the activity is classified as running.

The wind noise canceller 24 as well as the noise cancellation unit 22 are adjusted as a function of the respective class. Thus, the minimum and maximum cancellation performances of the wind noise canceller 24 are adjusted, that is to say the minimum and maximum components that are filtered out by means of the wind noise canceller 24 from the two audio signals provided by means of the microphone units 16. An adaptation rate of the wind noise canceller 24 is also adjusted, that is to say the rate at which a variation of wind noises identified in the respective audio signal is reacted to by means of a change of the filter effect.

For a classification as sitting, the maximum cancellation performance and the minimum cancellation performance are thus lowered and the adaptation rate is reduced to a minimum. For a classification as walking, the minimum cancellation performance is maintained but the maximum cancellation performance and the adaptation rate are increased slightly.

If the activity has been classified as bicycling or running, the maximum cancellation performance and the minimum cancellation performance are increased further. Since the head of the wearer of the hearing device 4 is exposed to comparatively strong relative wind or other wind when bicycling or running, relatively large amounts of wind noises are filtered out. The adaptation rate is likewise increased, although it is reduced slightly for classification as bicycling in comparison with running since a more pronounced head movement and direction change are possible when running, which leads to increased wind noises.

Moreover, the noise canceller 22 and the directionality of the microphone 14 are adjusted as a function of the classification. For the classification as bicycling or running, the directionality is thus reduced, which allows uniform recording of sound around the hearing device 4. In this way, it is possible for the wearer to reliably perceive any sources of danger, such as an approaching vehicle. Further, the cancellation performance of the noise cancellation unit 22 is adjusted to be relatively low for running and bicycling since background noises are usually artificial in origin and located at a particular place. When sitting or walking, on the other hand, the noise cancellation unit 22 is adjusted in such a way that relatively strong cancellation of background noises takes place. In summary, the classification is therefore carried out as a function of the ascertained variance 50 and the wind noise canceller 24 is adjusted as a function of the respective class, so that the wind noise canceller 24 is adjusted as a function of the ascertained variance 50 and as a function of the measurement data 46.

The invention is not restricted to the exemplary embodiment described above. Rather, other variants of the invention may also be derived therefrom by a person skilled in the art without departing from the subject matter of the invention. In particular, all individual features described in connection with the exemplary embodiment may furthermore also be combined with one another in a different way, without departing from the subject matter of the invention.

### LIST OF REFERENCE SIGNS

2 hearing device system
4 hearing device
6 external device
8 further motion sensor
10 further radio device
12 housing
14 microphone
16 microphone unit
18 signal processing unit
20 amplifier circuit
22 noise cancellation unit
24 wind noise canceller
26 receiver
28 sound tube
30 dome
32 motion sensor
34 radio device
36 battery
38 method for operating a hearing device system
40 further first working step
42 method for operating a hearing device
44 first working step
46 measurement data
48 time interval
50 variance
52 second working step

1-7. (canceled)

8. A method for operating a hearing device or a hearing aid, the method comprising:
providing a hearing device having a wind noise canceller and a motion sensor; and
adjusting the wind noise canceller as a function of measurement data recorded by the motion sensor.

9. The method according to claim 8, which further comprises adjusting a maximum cancellation performance of the wind noise canceller.

10. The method according to claim 9, which further comprises adjusting a minimum cancellation performance of the wind noise canceller.

11. The method according to claim 10, which further comprises adjusting an adaptation rate of the wind noise canceller.

12. The method according to claim 8, which further comprises using the measurement data to carry out a classification of an activity of a user of the hearing device, and adjusting the wind noise canceller as a function of the classification.

13. The method according to claim 8, which further comprises ascertaining a variance of the measurement data for successive time intervals, and adjusting the wind noise canceller as a function of the ascertained variance.

14. A hearing device or hearing aid, comprising:
an adjustable wind noise canceller; and
a motion sensor recording measurement data;
said wind noise canceller being adjusted as a function of the measurement data recorded by said motion sensor.
